(19) United States
(12) Patent Application Publication
(10) Pub. No.: US 2004/0223757 A1
(43) Pub. Date: Nov. 11, 2004

(54) Sector drive unit for camera

(76) Inventors: Yoichi Nakano, Chiba-ken (JP); Hiroshi Takahashi, Chiba-ken (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/825,551

(22) Filed: Apr. 14, 2004

(30) Foreign Application Priority Data
Apr. 14, 2003 (JP) 2003-109416

(51) Int. Cl. G03B 7/10

(52) U.S. Cl. 396/489

(57) ABSTRACT

A sector drive unit for a camera having one or more sectors provided on a base plate for opening and closing an aperture, an electromagnetic actuator for driving the sectors, and a driving force transmitting mechanism for transmitting a driving force of the electromagnetic actuator to the sectors and converting a prescribed amount of angular movement of the actuator in response to pulse of current or voltage into an amount of movement effective to drive the sectors to an aperture-opening position or an aperture-closing position, so that a cost-effective pulse drive circuit is provided with an increased opening and closing speed and a reduced time lag. In a preferred embodiment, a gear transmission mechanism is employed as the driving force transmitting mechanism and thus smooth operation of the sectors is achieved.

### BACKGROUND OF THE INVENTION

1. Field of the Invention

The present invention relates generally to a sector drive unit for a camera and, more particularly, to a sector drive unit for driving, for example, a light-shielding device of a digital camera.

2. Description of the Related Art

In a diaphragm device of a conventional silver-salt-film-type camera (hereinafter referred to as a “film-type camera”) or a light-shielding device for protecting an image pickup device of a digital camera, a mechanism for opening and closing an aperture by pivotal movement of plural sectors is generally employed. The diaphragm device and the light-shielding device are capable of opening and closing an aperture or adjusting the size of a diaphragm opening by pivoting a plurality of sectors by a drive motor. The sectors are driven by providing the drive motor with a sufficient amount of rotation for opening and closing the aperture by the sectors. Therefore, the drive motor is driven by an electric current having a number of drive pulses corresponding to the amount of desired movement of the sectors. For example, the light-shielding device for a digital camera is configured in such a manner that a light-shielding curtain is closed for protecting the image pickup device when not taking a picture, and opened by a shutter release operation when taking a picture, and is then closed again after having taken the picture. However, the drive motor of the light-shielding curtain is always supplied with electricity during such operations, and specifically, a plurality of current drive pulses are continuously supplied during the opening and closing operations.

As described above, it is necessary to provide a complex and expensive pulse drive circuit for supplying the appropriate number of current drive pulses to drive the motor to open and close the sectors. In addition, driving by use of a plurality of drive pulses generates a time lag, which results in a failure to open the shutter at precisely the right moment. Furthermore, in the case of the light-shielding device of a digital camera, electricity is continuously supplied for retaining the light-shielding curtain in a fully-opened state even during image reading by the image pickup device. This results in an increase in the amount of power consumption and the generation of noise.

### SUMMARY OF THE INVENTION

In order to solve the above-described problem, a sector drive unit for a camera according to the present invention includes one or more sectors capable of opening and closing an aperture formed on a base plate by a parallel link mechanism, an electromagnetic actuator for driving the sectors, and a driving force transmitting mechanism for transmitting the driving force of the electromagnetic actuator to the sectors and converting a prescribed amount of angular movement of the electromagnetic actuator into a sufficient amount of movement to drive the sectors from one of an aperture-opening position and an aperture-closing position to the other of the aperture-opening position and an aperture-closing position. Therefore, a cost-effective pulse drive circuit can be employed, the speed of the opening and closing operations can be increased, the time lag is advantageously reduced, and the need for an expensive pulse drive circuit may be avoided.

The driving force transmitting mechanism preferably includes a driving gear provided on a drive shaft of the electromagnetic actuator and a sector drive gear driven by the driving gear for driving the sectors. Since the driving force transmitting mechanism is configured as a gear transmission mechanism, smooth transmission of the driving force and an accurate speed ratio are ensured, and opening and closing of the aperture can be performed by driving the electromagnetic actuator.

A sector arm constituting a part of the driving force transmitting mechanism or the sectors is provided with a sector urging member for urging the sectors in one of the aperture-opening direction or the aperture-closing direction. By providing the sector urging member, rattling due to slight size variations and play in the parts of the driving force transmitting mechanism or among the sectors may be adjusted by urging these members in one direction, so that the aperture can always be opened and closed without variation. In particular, when a gear transmission mechanism is employed as the drive force transmitting mechanism, the influence in rattling due to backlash of the gears increases, and hence the presence of the sector urging member is very important.

### BRIEF DESCRIPTION OF THE DRAWINGS

FIG. 1 is a plan view showing a preferred embodiment of the sector drive unit of the present invention in a state where an aperture is fully closed;

FIG. 2 is a plan view showing the sector drive unit of the preferred embodiment in a state where the aperture is fully opened;

FIG. 3 is an enlarged, partly exploded, cross-sectional view of a principal portion of the sector drive unit;

FIG. 4 is an enlarged cross-sectional view of the principal portion of the sector drive unit; and

FIG. 5 is a time chart showing the operation of the embodiment shown in FIGS. 1-4.

### DESCRIPTION OF THE PREFERRED EMBODIMENTS

Referring now to the attached drawings, a preferred embodiment of the present invention will be described taking a light-shielding device of a digital camera as an example.

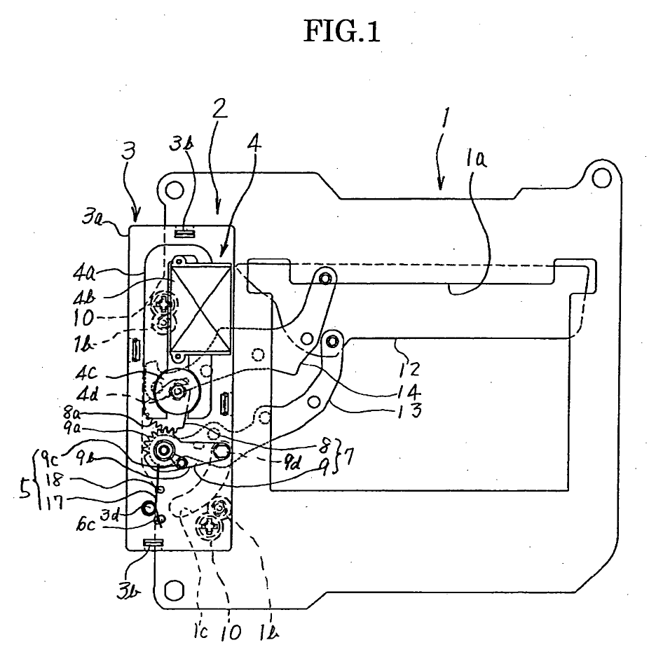

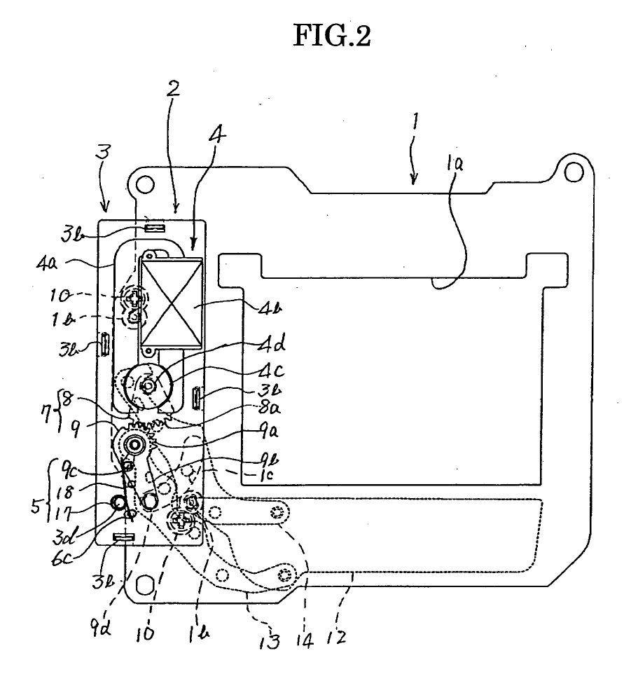

FIGS. 1 and 2 are enlarged views showing a principal portion of the light-shielding device described above. A detailed illustration of a printed circuit board P and a top plate of a unit case (described below) are omitted, and only the outline thereof is shown.

As shown in the drawings, the light-shielding device is structurally similar to a focal plane shutter in that an aperture can be opened and closed by a group of light-shielding vanes or sectors which superimpose and deploy with each other to open and close the aperture. However, the light-shielding device does not have a front curtain and a rear curtain as does the focal plane shutter. Instead, the light-shielding device simply has one light-shielding curtain which corresponds to either the front or the rear curtain of the focal plane shutter.

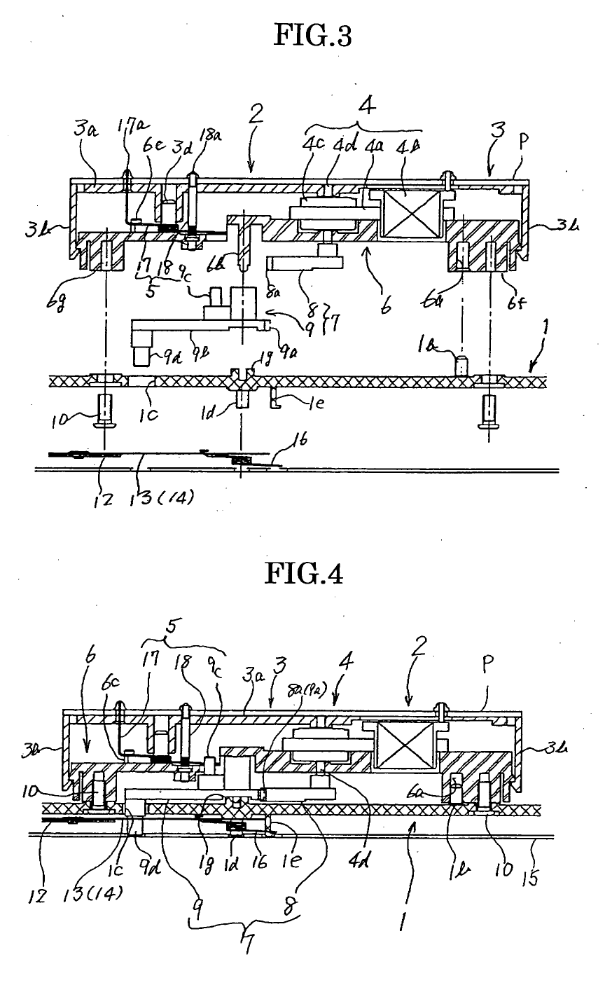

In FIGS. 1 and 2, a base plate 1 is formed of a plate member, which is formed at its periphery substantially into a rectangular shape, and an aperture 1a is provided at a position near the center thereof. The sector drive unit 2 for driving the sectors is mounted on the front surface (front side of the drawing) on the left side of the aperture 1a. The sector drive unit 2 is positioned by positioning pins 1b, 1b projecting outward from the front surface of the base plate 1, and fixed by screws 10, 10 as fixing members (See FIG. 3). Sector arms 13, 14 (described below) and sectors 12 are provided on the rear side of the base plate 1 opposed to the sector drive unit 2, so that the opening and closing operation of the aperture 1a by the sectors 12 via the parallel link mechanism can be carried out by the sector drive unit 2.

The sector drive unit 2 includes an electromagnetic actuator 4 mounted on a unit case 3 (hereinafter, referred to as an “actuator”) 4, a synchronous switch 5 serving as a sector position detecting unit (described below), a driving force transmitting mechanism 7 (described below) mounted on the lower side of an intermediate member 6, and the printed board P for supplying electric power to the actuator 4 and the synchronous switch 5. The sector drive unit 2 is positioned on the front surface of the base plate 1 and fixed to the base plate 1 via screws 10 as fixing members. The sectors 12 are provided on the rear surface of the base plate 1 so that the aperture 1a can be opened and closed by the driving force transmitting member 7.

FIG. 3 is an enlarged, partly exploded, cross-sectional view showing the components of the sector drive unit 2, sectors 12 and the sector arms 13, 14 in a disassembled manner. The drive unit including the actuator 4 and the synchronous switch 5 in the driving mechanism of the sector drive unit 2 is fixed to one of the surfaces (the lower surface in FIG. 3) of the unit case 3 via the intermediate member 6. The printed board P is fixed to the other surface (the upper surface in FIG. 3) of the unit case 3. An upper plate 3a of the unit case 3 is formed of a rectangular plate-shaped member (See FIG. 1) and is provided with locking portions 3b, 3b for removably retaining the intermediate member 6 at both ends thereof. The intermediate member 6 retains the actuator 4 and the synchronous switch 5 between the unit case 3 and the intermediate member 6 and is provided with mounting portions 6f, 6g for removably mounting the unit case 3 to the base plate 1. The intermediate member 6 is also provided with the driving force transmitting mechanism 7 on the outer surface (the lower surface in FIG. 3). The sector drive unit 2 is connected to the base plate 1 by aligning the positioning pin 1b and a positioning hole 6a of the intermediate member 6, inserting the same therein, and securing them with the screws 10 as fixing members. On the other surface (the lower surface in FIG. 3) of the base plate 1, the sectors 12 are provided so as to be capable of opening and closing the aperture 1a (See FIG. 1). Since the sector drive unit 2 constitutes a unit structure that allows it to be easily attached and detached with respect to the base plate 1, it can be mounted to various types of base plates or sectors.

The above-described actuator 4 employs a known pulse motor which includes a stator 4a, a drive coil 4b, and a rotor 4c formed of a permanent magnet. The actuator 4 is configured such that an angle of rotation of the rotor 4c when one voltage or current drive pulse is applied (step angle) is defined by the relation between the positions of the magnetic poles of the rotor 4c and the positions of the magnetic poles provided on the stator 4a. The positions of the magnetic poles of the stator 4a are static stable positions at which the rotor 4c is retained without the supply of power. Therefore, when the magnetic poles of the rotor 4c move between the magnetic poles of the stator with the supply of power, the rotor 4c can be maintained at any of the static stable positions without supplying power. The number of static stable positions is determined by the number of magnetic poles of the rotor 4c and the number of magnetic poles provided on the inner peripheries of the recesses of the stator 4a, which surround the rotor. In the present embodiment, two static stable positions are provided by the combination of two magnetic poles on the rotor and four magnetic poles on the stator.

The actuator 4 is secured in a state of being pressed against a top board member 3a of the unit case 3 by the intermediate member 6. A rotary shaft 4d is formed integrally with the rotor 4c so as to penetrate the intermediate member 6 and project from the lower surface thereof. A drive lever 8 constituting a part of the drive force transmitting mechanism 7 is provided at the extremity (lower end in FIG. 3) of the rotary shaft 4d of the actuator 4. A sector drive lever 9 capable of being moved in conjunction with the drive lever 8 is pivotably supported by a shaft member 6b projecting from the lower surface of the intermediate member 6. The sector drive lever 9 constituting a part of the driving force transmitting member 7 is interlocked with the drive lever 8 by engagement of teeth (sector driving gear) 9a with teeth (driving gear) 8a of the drive lever 8. The drive lever 8 is formed of a fan-shaped plate member fanning out to a small extent, and the narrow end portion of the fan is secured to the rotary shaft 4d of the actuator 4 so as to be capable of integrally rotating therewith. The teeth 8a of the drive lever 8 are formed or machined on an arcuate portion formed at the extremity of the drive lever 8.

As shown in FIGS. 1 and 2, the sector drive lever 9 has a portion formed into an arcuate shape at a predetermined distance from the rotational center, and this arcuate portion is provided with the teeth 9a along part of the periphery thereof. The driving force transmitting member 7 includes a gear transmission mechanism including the teeth 8a, 9a, and the speed ratio (gear ratio) of the gear transmission mechanism is inversely proportional to the distance from the rotational center of each lever to each pitch circle (radius of the pitch circle). Therefore, by providing several sets or different combinations of the drive lever 8 and the sector drive lever 9 each having a different gear ratio for use with various types of sectors, the flexibility of design and manufacture increases significantly. By making the step angle of the actuator 4 and the pivotal angle of the sector arm 13 the same, one-pulse drive of the actuator 4 can move the sectors 12 by an appropriate amount required for fully opening or closing the aperture 1a. This structure contributes to downsizing or cost reduction of the camera since it avoids the need to provide a pulse drive circuit which is expensive and generates complex pulses continuously.

Part of the arcuate portion of the sector drive lever 9 which is not provided with the teeth 9a extends outward and is formed into an arm member 9b. In the vicinity of the boundary between the arcuate portion and the arm member 9b, a contactable pin 9c is provided so as to project upward as shown in FIG. 3. On the lower surface of the extremity of the arm member 9b, there is provided a drive pin 9d for driving the sectors 12 described above.

In this manner, the driving force transmitting mechanism 7 is configured in such a manner that the drive member 8 pivots by an angle corresponding to the rotational angle (step angle) of the rotor 4c of the actuator 4, and the sector drive lever 9 interlocked with the drive lever 8 via the respective teeth pivots by an angle corresponding to the ratio of the distances from the respective pivots to the pitch circles of the respective teeth. In this embodiment, the driving force transmitting mechanism is a gear transmission mechanism. The pivotal angle of the sector drive lever 9 is the same as the pivotal angle of the sector arm 13 constituting the sectors 12. Thus, the amount of reciprocal movement of the sectors 12 is determined by the pivotal angle of the sector drive lever 9 and the length of the sector arm 13. In the drawing, the distances from the pivots of the respective lever to the pitch circles are illustrated to be different from each other, and hence seem to be different in pivotal angle as well. However, when the torque of the actuator 4 is considered, it is preferable to set each pivotal angle to substantially the same value.

The synchronous switch 5 will now be described. The synchronous switch 5 used in this light-shielding device is a sensor for detecting the opening state of the sector drive lever 9 and verifying that the sectors 12 are fully opened during exposure. The synchronous switch 5 includes a detection spring 17, a detection pin 18, and the contactable pin 9c. The detection spring 17 employed herein is a helical torsion coil spring having straight portions extending in opposite directions at both ends. The coil portion of the spring at the center is fitted on the shaft 3d projecting from the unit case 3 so that a first one of the straight portions can abut against the contactable pin 9c of the sector drive lever 9. The second straight portion of the detection spring 17 is limited in the range of its pivotal movement by abutting against a projection 6c projected from the front surface of the intermediate member 6. The second straight portion of the detection spring 17 is bent and extends upward at a right angle and an end thereof is brought into electrical communication with the printed board P to function as an information output section 17a, so that the detected data can be supplied to the CPU of the camera body.

The detection pin 18 is a conductive round rod member supported between the printed board P and the intermediate member 6 at both ends, so as to electrically communicate with the printed board P. The detection pin 18 is arranged at the position where it can abut against the intermediate position of the first straight portion of the detection spring 17 when the sectors 12 are closed and the aperture 1a in a closed state, and it can move apart from the straight portion when the sectors 12 are opened and the aperture 1a is in the fully-opened state. Detected data indicating whether the detection spring 17 and the detection pin 18 are in contact with each other or out of contact with each other can be supplied from terminals 17a, 18a provided on the printed board P. The action by which the detection spring 17 is brought into and out of contact with the detection pin 18 is performed by causing the detection spring 17 to follow the pivotal movement of the contactable pin 9c which is formed integrally with the sector drive lever 9.

FIG. 4 shows a state in which the sector drive unit 2 is mounted to the base plate 1. In this mounted state, the sector drive lever 9 is pivotably supported by a shaft member 6b projecting from the intermediate member 6 and by a projection 1g projecting from the base plate 1, and the drive pin 9d penetrates an arcuate groove 1c on the base plate 1 and projects to the back surface thereof.

The sectors 12 and the sector arms 13, 14 for opening and closing the aperture 1a are provided on the back surface of the base plate 1. The base plate 1, the sectors 12, and the sector arms 13, 14 constitute a sector unit. The sectors 12 are, as shown in FIGS. 1 and 2, configured as a parallel link mechanism including a plurality of sectors 12 (although only one is shown in the drawings) and the first and second sector arms 13, 14 for driving the sectors. The first sector arm 13 of the sector arms forming the parallel link mechanism, being positioned on the lower side, is pivotably supported by a shaft 1d (See FIG. 3) provided concentrically with the rotational center of the sector drive lever. The drive pin 9d of the sector drive lever 9 is inserted into a hole (not shown) formed at the intermediate position of the first sector arm 13, so that the arm can be driven by the sector drive lever. The extremity of the first sector arm 13 is pivotably connected to the sectors 12 by connecting pins 13a. The second sector arm 14 positioned above the first sector arm 13 is pivotably supported on the front surface of the base plate 1 at a position spaced slightly apart from the position where the first sector arm is supported. In association therewith, the extremities of the sector arms 13, 14 are pivotably connected to the sectors 12 to configure the parallel link mechanism, so that the sectors 12 can be moved in a linked manner.

As shown in FIG. 4, a sector urging spring 16 for urging the sectors 12 toward the first sector arm 13 in one direction is provided on the back surface of the base plate 1. The sector urging spring 16 comprises a helical torsion coil spring. The coil portion at the center of the sector urging spring 16 is inserted onto the shaft 1d, which supports the first sector arm 13, and one of the straight portions extending from the coil portion abuts against a locking projection 1e projecting on the back surface of the base plate 1. The other straight portion of the sector urging spring 16 abuts against the side portion of the first sector arm 13 to urge the arm in the direction to open the sectors 12. One function of the sector urging spring 16 is to facilitate the opening operation of the sectors 12 by urging the sector arm 13 at the time of a shutter release operation when the sectors 12 are in the initial positions. Another function is to reduce the gap and thus the rattling generated between the driving force transmitting member 7 and the sectors 12 by pressing them in one direction, which is referred to as “positional adjustment” when the aperture 1a is brought into an opened state. It is also possible to configure the sector urging spring 16 to urge the sector arm 13 in the closing direction of the sectors 12. The sector urging member 16 and the sectors 12 are protected by a vane retaining plate 15.

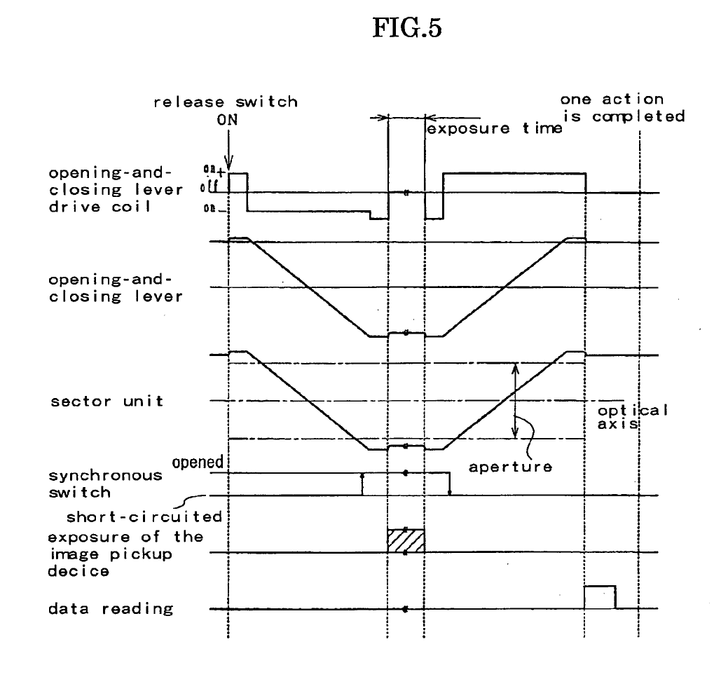

Referring now to the timing chart shown in FIG. 5, operation of the present embodiment will be described. Among the elements arranged along the ordinate shown in FIG. 5, the phrase “opening-and-closing lever drive coil” designates the drive coil 4b of the actuator 4 in the above-described configuration, the “opening-and-closing lever” represents a lever of the driving force transmitting member 7, more specifically, the sector drive lever 9. The phrase “exposure of the image pickup device” designates the operation of converting an image of an imaged object into a digital signal. The abscissa axis of FIG. 5 designates a time period, and the ratio of the length of the time periods is not shown as the actual ratio but rather is exaggerated for the sake of convenience of description.

In the initial state, the supply of power to the drive coil 4b of the actuator is turned OFF, and the sector drive lever 9 and the sectors 12 remain at an initial position (static stable position). At this time, the detection spring 17 and the detection pin 18 of the synchronous switch 5 abut against each other (short-circuited) (See FIG. 1). Subsequently, when a release switch (not shown) of the camera body is turned ON, a positive electric current for rotating the rotor in the direction in which the sectors 12 close the aperture 1a is supplied from the CPU, and positional adjustment of the sectors 12 is performed. Subsequently, a negative electric current is supplied by the CPU to the drive coil 4b of the actuator in the direction opposite from the case of positional adjustment, and the rotor 4c rotates in the opposite direction to open the sectors 12 via the driving force transmitting member 7. At this time, activation of the sectors can easily be made because of the urging force of the sector urging spring 16. When the opening operation of the sectors 12 is completed, and the aperture 1a is fully opened, an electric current is further supplied in the same direction to prevent rebounding of the sectors 12, that is, positional adjustment is performed. The positional adjustment can be performed continuously by the sector urging member 16 even in the period when the power distribution to the coil 3b is turned OFF.

In a state in which the sectors 12 are completely opened, that is, in a state in which the sectors 12 are retracted to open the aperture 1a, the contactable pin 9c of the sector drive lever abuts against the first straight portion of the detection spring 17 of the synchronous switch 5 and presses it counterclockwise. Therefore, the detection spring 17 moves away (is opened) from the detection pin 18 (See FIG. 2), and signal data generated by the change of the switching state is output. The CPU receives the signal data indicating the change of state, verifies that the aperture 1a is in the opened state, and then turns OFF the supply of power to the drive coil 4b and supplies an exposure-start signal to the image pickup device to initiate exposure. Since the supply of power to the drive coil 4b of the actuator 4 is turned OFF in association with the initiation of the exposure operation, generation of noise during the exposure operation is prevented and power consumption is reduced. Since the rotor 4c is retained at a static stable position with no power supply even while the power supply to the drive coil 4b is turned OFF, the sectors 12 are prevented from moving inadvertently.

Upon completion of the exposure operation, a negative electric current for driving the sectors 12 in the opening direction in which the sectors 12 are superimposed is supplied to the drive coil 4b of the actuator again to perform positional adjustment. Subsequently, a positive electric current for driving the sectors 12 in the closing direction in which the sectors 12 are closed is supplied to the drive coil 4b, so that the sector drive lever 9 is rotated, whereby the sectors 12 are closed in conjunction therewith. At this time, in FIG. 1, when the sector drive lever 9 is rotated counterclockwise, the detection spring 17 of the synchronous switch 5 is returned to an original position, whereby the first straight portion of the detection spring moves away from the detection pin 18. Accordingly, the direction of the output signal from the synchronous switch 5 is changed, and the CPU receives the output and verifies the initiation of the operation to close the aperture 1a. In this manner, the sectors 12 are returned to their original positions. However, the supply of power to the drive coil 4b is continued in the same direction to the drive coil 4b for a predetermined time period for positional adjustment even after the returning motion of the driving force transmitting member 7 and the sectors 12 is completed, and then the supply of power is turned OFF to return them to their initial positions. Upon termination of the supply of power to the drive coil 4b, image data accumulated in the image pickup device by exposure is supplied to the CPU, whereby one operation to take a picture is completed. Data read is supplied to the storage device in the camera body and is stored therein.

While the sector drive unit for a camera according to the present invention is configured as a light-shielding device of a digital camera, the present invention is not limited thereto, and may be used in a digital camera provided with a diaphragm-type shutter or a focal plane shutter, as well as in other general camera types such as a diaphragm device of a film camera. Although in the foregoing description, the actuator 4 is driven by a constant voltage circuit, it is also possible to drive the actuator 4 by use of a constant current circuit. The gear transmission mechanism is used as the driving force transmitting mechanism in the foregoing description, though the present invention is not limited thereto, and a link mechanism or a slider crank mechanism may also be employed. While the sectors are driven by one-pulse drive of the actuator in the present embodiment, it is also possible to apply a plurality of drive pulses to the electromagnetic actuator for adjusting the driving speed of the sector.

According to the present invention, since the aperture can be opened and closed by the sectors by driving the electromagnetic actuator, the operating time of the sectors can be reduced. In addition, by employing the gear transmission mechanism as the driving force transmitting mechanism, smooth power transmission is enabled, and hence quick operation of the sectors is achieved. Furthermore, when the sector urging spring 16 for urging the sector drive lever 9 in one direction is provided on the driving force transmission mechanism or the sectors, absorption of deformation or rattling generated by the driving force transmitting mechanism or the sectors is enhanced, and hence a stable opening and closing state of the aperture is ensured.

What is claimed is:

1. A sector drive unit for a camera comprising:
a base plate provided with an aperture;
one or more sectors for opening and closing the aperture;
an electromagnetic actuator for driving the sectors to open and close the aperture; and
a driving force transmitting mechanism for transmitting a driving force of the electromagnetic actuator to the sectors and converting a prescribed amount of angular movement of the electromagnetic actuator into a sufficient amount of movement to drive the sectors from one of an aperture-opening position and an aperture-closing position to the other of the aperture-opening position and an aperture-closing position.

2. A sector drive unit for a camera according to claim 1; wherein the electromagnetic actuator comprises a pulse motor which undergoes the prescribed amount of angular movement in response to application thereto of a prescribed number of voltage or current pulses for driving the sectors to either the aperture-opening position or the aperture-closing position depending upon the polarity of the pulses.

3. A sector drive unit for a camera according to claim 2; wherein the prescribed number of voltage or current pulses comprises one voltage or current pulse.

4. A sector drive unit for a camera according to claim 2; wherein the pulse motor comprises a rotor having a plurality of magnetic poles, a stator having a plurality of magnetic poles, and a drive coil for driving the rotor, an angle of rotation of the rotor in response to application of one voltage or current pulse to the drive coil being defined by a relationship between positions of the magnetic poles of the rotor and positions of the magnetic poles provided on the stator.

5. A sector drive unit for a camera according to claim 4; wherein the positions of the magnetic poles provided on the stator are static stable positions at which the rotor is retained without the supply of power to the drive coil.

6. A sector drive unit for a camera according to claim 1; wherein the driving force transmitting mechanism comprises a drive gear provided on a drive shaft of the electromagnetic actuator and a sector drive gear driven by the driving gear for driving the sectors.

7. A sector drive unit for a camera according to claim 1; further comprising a sector urging spring provided on the driving force transmitting mechanism or on a sector for urging the sectors in one of the aperture-opening direction and the aperture-closing direction.

8. A sector drive unit for a camera according to claim 1; further comprising a case removably mounted to the base plate and containing therein the electromagnetic actuator and the driving force transmitting mechanism.

9. A sector drive unit for a camera according to claim 1; further comprising a sector position detecting unit for detecting when the sectors are in at least one of the aperture-opening position and the aperture-closing position.

10. A sector drive unit for a camera according to claim 9; wherein the sector position detecting unit comprises a conductive spring element having a portion that undergoes movement with the driving force transmitting mechanism to come into and out of contact with a conductive member.

11. A sector drive unit for a camera according to claim 1; wherein the one or more sectors comprise a plurality of sectors each having a sector arm connected thereto, and the sector arms are interconnected to cooperatively drive the sectors to open and close the aperture.

12. A sector drive unit for a camera comprising:
a sector unit having a base plate provided with an aperture, one or more sectors movably mounted adjacent to the aperture for opening and closing the aperture, and a sector arm for driving the one or more sectors to open and close the aperture; and
a sector driving unit having an electromagnetic actuator and a driving force transmitting mechanism for converting a rotary driving force of the electromagnetic actuator into movement of the sector arm.

13. A sector drive unit for a camera according to claim 12; wherein the one or more sectors comprise a plurality of sectors each having a sector arm connected thereto, and the sector arms are interconnected to cooperatively drive the sectors to open and close the aperture.

14. A sector drive unit for a camera according to claim 12; wherein the sector driving unit further comprises a case removably mountable to the base plate for housing the electromagnetic actuator and the driving force transmitting mechanism.

15. A sector drive unit for a camera according to claim 12; wherein the sector driving unit further comprises a sector position detecting unit for detecting a position of the one or more sectors.

16. A sector drive unit for a camera according to claim 15; wherein the sector position detecting unit comprises a conductive spring element having a portion that undergoes movement with the driving force transmitting mechanism to come into and out of contact with a conductive member.

17. A sector drive unit for a camera according to claim 11; wherein the driving force transmitting mechanism converts a prescribed amount of angular movement of the electromagnetic actuator into an amount of angular movement of the sectors sufficient to drive the sectors from one of an aperture-opening position and an aperture-closing position to the other of the aperture-opening position and the aperture-closing position.

18. A sector drive unit for a camera according to claim 17; wherein the electromagnetic actuator comprises a pulse motor which undergoes the prescribed amount of angular movement in response to application thereto of a prescribed number of voltage or current pulses for driving the sectors to either the aperture-opening position or the aperture-closing position depending upon the polarity of the pulses.

19. A sector drive unit for a camera according to claim 18; wherein the prescribed number of voltage or current pulses comprises one voltage or current pulse.

20. A sector drive unit for a camera according to claim 18; wherein the pulse motor comprises a rotor having a plurality of magnetic poles, a stator having a plurality of magnetic poles, and a drive coil for driving the rotor, an angle of rotation of the rotor in response to application of a voltage or current pulse to the drive coil being defined by a relationship between positions of the magnetic poles of the rotor and positions of the magnetic poles provided on the stator.

21. A sector drive unit for a camera according to claim 20; wherein the positions of the magnetic poles provided on the stator are static stable positions at which the rotor is retained without the supply of power to the drive coil.

22. A sector drive unit for a camera according to claim 12; wherein the driving force transmitting mechanism comprises a drive gear provided on a drive shaft of the electromagnetic actuator and a sector drive gear for driving the sectors.

23. A sector drive unit for a camera according to claim 12; further comprising a sector urging spring provided on the driving force transmitting mechanism or on a sector for urging the sectors in one of the aperture-opening direction and the aperture-closing direction.
